(19) United States
(12) Patent Application Publication
(10) Pub. No.: US 2018/0225617 A1
(43) Pub. Date: Aug. 9, 2018

(54) METHOD AND SYSTEM FOR AUTOMATED WORK PATTERN QUANTIFICATION

(71) Applicant: GOOGLE INC., Mountain View, CA (US)

(72) Inventors: Patrick LEUNG, New York, NY (US); Geoff STEARNS, Long Island, NY (US); Nick SIDERAKIS, Albertson, NY (US); Kirill TITIEVSKY, Brooklyn, NY (US); Benjamin GOJMAN, Hamilton, NJ (US); Zachary YORKE, Brooklyn, NY (US); Xiaolan ZHANG, Chappaqua, NY (US); Adrien BARANES, New York, NY (US); Samuel HOFFSTAETTER, New York, NY (US)

(73) Assignee: GOOGLE INC., Mountain View, CA (US)

(21) Appl. No.: 15/425,611

(22) Filed: Feb. 6, 2017

(51) Int. Cl. G06Q 10/06

(52) U.S. Cl. CPC G06Q 10/06398

(57) ABSTRACT

A method and system for automating work pattern quantification and providing worker feedback based on quantified metrics is provided. The system may first identify a work pattern to be quantified for a user. Using one more predefined rules associated with the identified work pattern, the system determines at least one task associated with the work pattern. One or more services accessed to perform the associated task(s) are identified and event data from these services is collected, each event including an associated timestamp. The event data is analyzed to generate a focus metric(s). The generated focus metrics may then be used to quantify a work pattern by providing individual or group feedback.

### BACKGROUND

Productivity is sometimes quantified and measured in terms of the rate of output per unit of input, e.g., number of widgets produced per hour. However, this common measure of productivity is difficult to translate to knowledge workers whose input and output are not easily quantified. As a result, knowledge worker productivity was not traditionally objectively quantified.

Research has shown that uninterrupted concentration time may be useful for worker productivity in knowledge-based job industries, for example, software development. Accordingly, knowledge workers may equate an increase in uninterrupted concentration time with increased productivity. This has resulted in acceptance of practices intended to increase concentration time, for example, defragmenting their calendars or only checking email at certain times during the day. However, in order to evaluate the impact of these practices, knowledge workers are required to manually track their production related activities which is not only time consuming but detrimental to the practices they are trying to implement. As a result it is difficult for knowledge workers to quantify whether their efforts actually impact their work patterns.

Despite the desirability to increase productivity through increased concentration, also referred to as focus, knowledge workers lack an automated process/tool for quantifying their work patterns and/or measuring how changes to their work patterns impact their focus/concentration. Similarly, companies lack a framework to assess how infrastructure, such as office space, worker equipment, and environmental factors, such as corporate services, workplace atmosphere, and the like, impact work patterns and/or knowledge worker focus.

### SUMMARY

The inventors have acknowledged that there is a need for a tool which automates the process of quantifying work patterns and provides feedback on worker focus.

This specification describes methods and systems for automating work pattern quantification, in general, and specifically for providing focus feedback to knowledge workers based on quantified work patterns.

In general, one aspect of the subject matter described in this specification can be embodied in a method for automating work pattern quantification and providing worker feedback based on quantified metrics, the method including: identifying a work pattern to be quantified for a user; determining, using one or more predefined rules associated with the identified work pattern, at least one task associated with the work pattern; identifying one or more services accessed to perform the at least one task; collecting events from the one or more determined services, each of the collected events having an associated timestamp; filtering the collected events to remove events not associated with the at least one task and the user; aggregating the filtered events into event sessions, wherein an event session is a sequence of events where each subsequent event occurred within a predefined time period Tᵢ of the previous event; analyzing the event sessions to generate a focus metric associated with the at least one task; and quantifying the work pattern by providing feedback based on the focus metric.

These and other embodiments can optionally include one or more of the following features. Analyzing the event sessions may include aggregating the event sessions into focused and unfocused sessions and generating the focus metric based on the focused and unfocused sessions. An event session may be considered focused if the time period from the first event in the session to the last event in the session is greater than a predefined time period T_{f}. The time period used to define event sessions, Tᵢ, and the time period used to define focused sessions, T_{f}, may varying based on the task associated with the session. The focus metric may include a focus index or a fragmentation index. In some implementations a plurality of tasks may be determined to be associated with a work pattern and analyzing the event sessions to generate a focus metric may include identifying event sessions having overlapping time periods as multi-tasking sessions; and generating the focus metric based on the multi-tasking sessions

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating a process for identifying work patterns and generating work pattern rules for quantification of the work patters according to an embodiment.

FIG. 2 is a block diagram illustrating a process for generating a focus metric according to an embodiment.

FIGS. 3A-3C illustrate focus metric user feedback summaries according to embodiments.

FIG. 3D illustrates a calendar overlay according to an embodiment.

FIG. 4 illustrates aggregation of collected events into event sessions and event sessions into focused and unfocussed sessions according to an embodiment.

FIG. 5 is a block diagram of a framework for automating work pattern quantification according to an embodiment.

FIG. 6 is a block diagram illustrating a computing device.

### DETAILED DESCRIPTION

According to an embodiment, a work pattern quantifier tool captures information about knowledge worker work patterns in the workplace, processes and aggregates the captured information, and then provides feedback to knowledge workers about their focus. This feedback may take the form of, for example and without limitation, focus metrics and/or a dashboard that visualizes the captured work patterns, as well as recommendations that support changes to work patterns and provide quantified feedback.

For the purposes of explanation and clarity, the embodiments disclosed herein are described with respect to knowledge workers in software development, i.e., software engineers. However, the invention should not be limited to just this example, as the tools and methods disclosed herein may be applied to any knowledge worker environment.

Productivity Metrics Based on Quantified Work Patterns

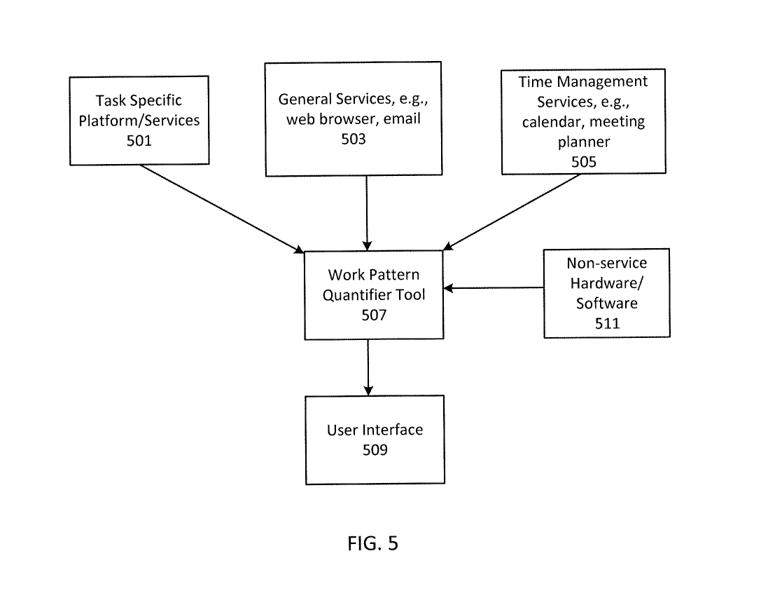

According to embodiments, the work pattern quantifier tool (herein “quantifier tool”) may collect information on work patterns from various sources. As shown in FIG. 5, the quantifier tool (507) may receive work pattern data and/or other information from a plurality of services, for example and without limitation, task specific services (501), general services (503), and time management services (505). Task specific platforms/services (501) include those services and/or platforms whose primary purpose is to help knowledge workers perform their assigned job tasks, for example, document authoring tools/services, interactive development environments (IDEs) for code development, and code editors. General services (503) include services that may be used to help a knowledge worker complete/perform their assigned job task, but whose primary purpose is more general, such as electronic mail services, web browsers, conferencing systems, storage networks and the like. Time management services (505) includes those services and/or applications which help knowledge workers manage their time/schedules, for example, calendar applications and meeting planning services. Although specific software development related service examples have been provided other services may be used. It should be noted that a particular service may be considered task specific with respect to one job and a general service to another job.

In addition, the quantifier tool (507) may receive data from non-service related hardware and/or software (511). The non-service related hardware and/or software (511) may include, for example and without limitation, sensor data from mobile devices, sensor data about or from the work environment, or personal sensors/devices worn by a knowledge worker. Data and/or feedback from knowledge workers themselves may also be provided via a user interface (509). The quantifier tool (507) may analyze data collected from the various services and/or sensors and calculate metrics in order to quantify work patterns (discussed in more detail below).

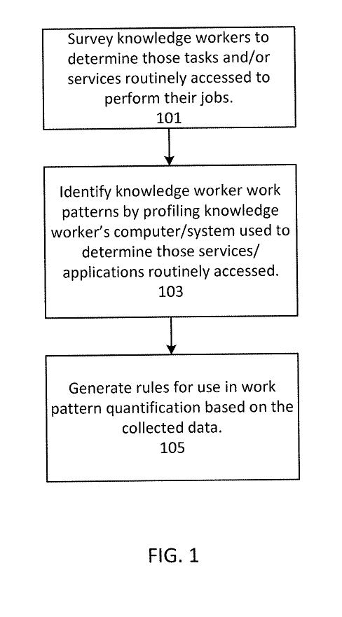

With reference to FIG. 1, the quantifier tool (507) may collect/capture information about knowledge worker work patterns (Step 101 & 103) in the workplace to generate rules for use in work pattern quantification (Step 105). In some embodiments, the work pattern may be identified by surveying a knowledge worker to determine the tasks they consider productive and/or which they want to track (Step 101). In addition, or alternatively, work patterns may be identified by profiling a worker's computer and/or system usage to determine those services routinely accessed (Step 103). A work pattern includes at least one task which the knowledge worker wishes to quantify. For example, software engineers may wish to quantify and/or improve their coding efficiency by increasing their uninterrupted coding time. The quantifier tool may therefore, first collect information regarding a software engineer's interactions with the various services he or she uses each day in order to do his or her job, including task-specific services, such as coding platforms, editors, and the like, as well as general services such as email, calendar, websites, and the like. For example, a software engineer may check email, type a document, write code in an interactive development environment (IDE), build code in a build system, run code in a coding platform that may include a testing environment, check code into a code repository, and save copies of documents and code in a file system. Information may be collected from each one of these systems in order to determine the tasks on which a software engineer spends time and how much time is spent doing each task. Based on the information, the quantifier tool (507) identified one or more predefined rules for quantifying coding efficiency (Step 105).

When a worker is focused on a task, for example, coding or authoring a document, the worker continuously interacts with an associated service. For example, when writing code, the worker may interact with an IDE or coding platform; when authoring a document, the worker may interact with a word processing platform, file system, and file storage platform. As a result of these interactions, a steady stream of events may be logged by the associated service(s). These services typically log user events along with a timestamp which indicates when the event occurred. For example, a software engineer may save a document in a word processing platform or save source code in a coding platform. Each of these save events may be logged along with a timestamp for the event. Coding events may also include revision tracking, starting a debug session, a compile start, a run start, and/or a simulator start. An email system may log email open and close events, compose email start and stop events, email sent and receive events and the like. An IDE may log file open and close events, save events, compile events, run events, debug events, links to bug IDs, and the like. The quantifier tool allows this event data to be used to automate work pattern quantification by generating predefined rules which allow the tool to determine which events are relevant to a specific work pattern, for example, by identifying the one or more tasks associated with a specific work pattern and/or one or more services from which to capture event data for each of the identified tasks. Generation of these rules allows the quantifier tool to automate the monitoring process needed to quantify a specific work pattern.

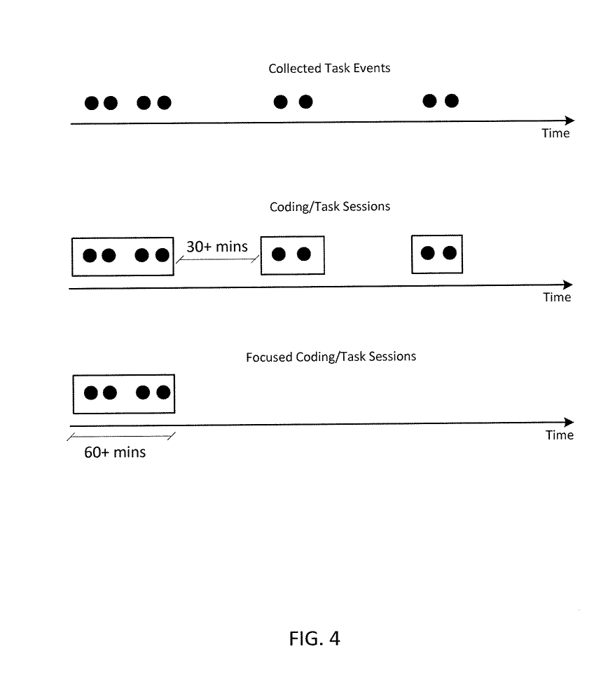

For example, it is customary for coding platforms and/or authoring services to periodically save files if changes have been made. Therefore, the quantifier tool (507) may take advantage of this feature and generate rules for converting save events into sets of coding sessions based on whether two save events occur within a predetermined time period, for example, 30 minutes. The quantifier tool may be tune or vary over time the predeteimined time period to reflect changes in work patterns. Using the generated rule providing the 30 minute time period, the quantifier tool will consider two save events to be in the same coding session if the second save event occurs within 30 minutes of the first. Otherwise, the first event is considered the end of a coding session and the second event the start/beginning of the next coding session as illustrated in FIG. 4. Another coding session rule may be that a coding session is always considered to begin 5 minutes before its first save-event to capture the fact that a worker must have done some coding before the first save event. The time period may be defined based on external information, for example, the automatic save interval of the coding service. In addition, the tasks or work patterns associated with a rule, for example a meeting, may establish natural session boundaries, for example, start of the meeting and end of the meeting.

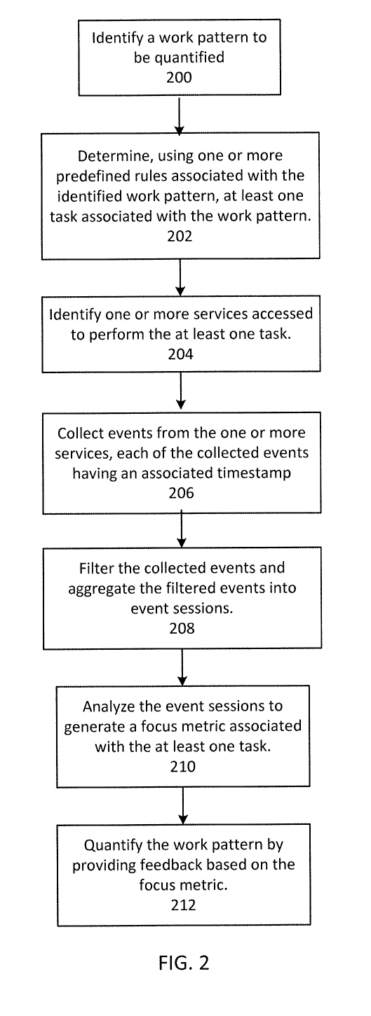

A process for automating work pattern quantification and providing worker feedback based on the quantified metric(s) according to an embodiment is illustrated in FIG. 2. A knowledge worker identifies, via the quantifier tool's user interface (509), a work pattern to be quantified, for example coding efficiency (Step 200). The quantifier tool (507) determines at least one task to be quantified using one or more predefined rules associated with the identified work pattern (Step 202) and one or more services accessed to perform the at least one task (Step 204). The quantifier tool (507) then collects event data, including the associated timestamps, from the one or more services (Step 206).

The quantifier tool (507) may collect/receive the event data from the various services using any one or more of the following methods. The quantifier tool (507) may request/capture the event data from the services by accessing service logs, using service APIs, and/or sending request messages for specific data. The event data may be pushed to the quantifier tool (507) from the various services. The quantifier tool (507) may subscribe to an event channel and process published event updates.

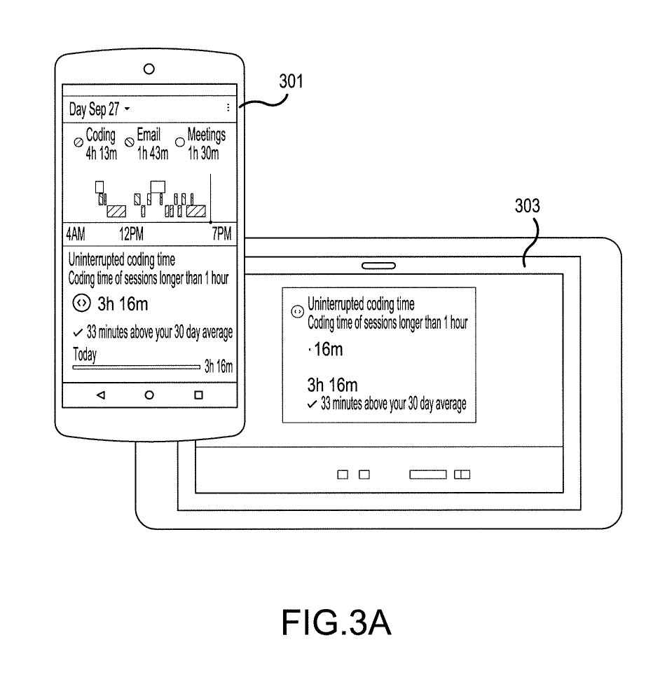

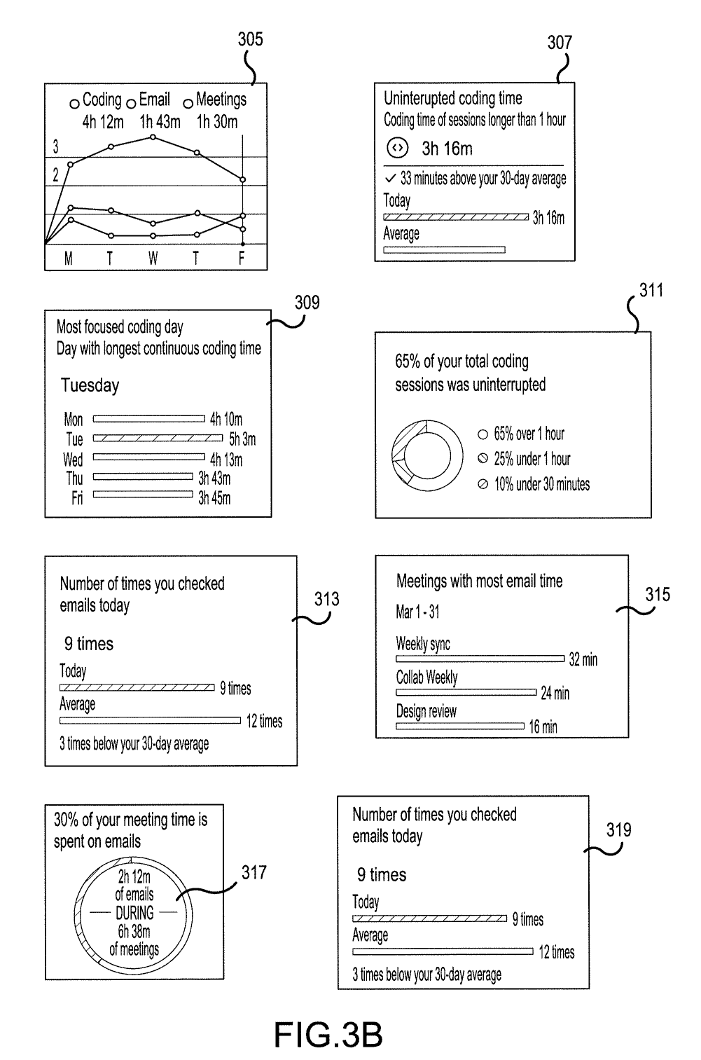

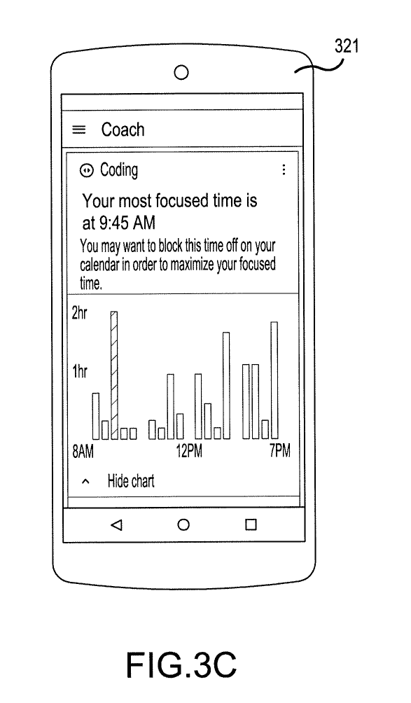

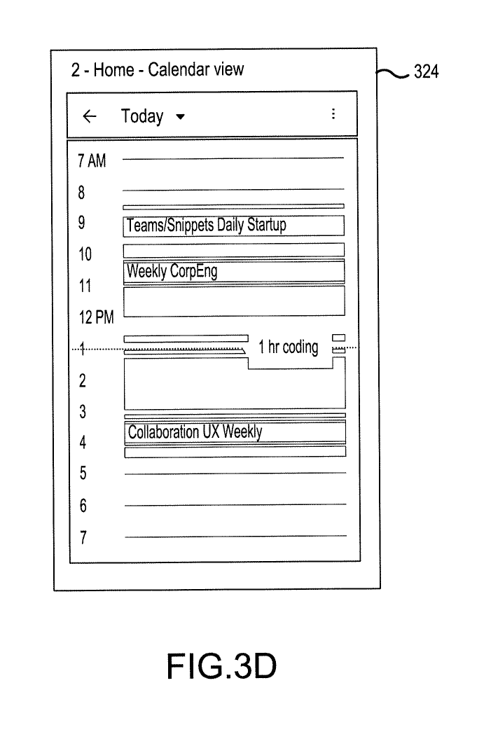

The quantifier tool (507) may use these event data points to calculate various focus metric(s) (107). The generated focus metric(s) may then be used to quantify a work pattern by providing individual or group feedback (212). According to an embodiment the focus metrics may be used to quantify the work pattern at different levels of granularity discussed below in more detail with respect to FIGS. 3A-3C.

With reference to FIGS. 2 and 4, analyzing the event data includes filtering and ordering the events into time sequences of events and aggregating the event sequences into sessions based on the predefined rules associated with the task and/or work pattern being quantified (Step 208), for example focused and unfocused. Because the event data may comprise data associate with various tasks and individuals, the event data is first filtered based on associated task (202). This filtering removes events not associated with the task and/or work pattern being quantified. Prior to filtering based on event relevance, the event data may be filtered to distinguish system-generated versus user-generated events and then sub-filtered based on various criteria. System-generated events are generated by the service automatically, for example and without limitation, a service which includes auto save may generate a save event automatically at predefined intervals. User-generated events are events logged as the result of a user action, for example and without limitation, opening a file, starting a debug run, or saving a document. The filtered data is then aggregated into events sessions for a particular task (Step 208). A session is a sequence of events where each subsequent event occurred within a predefined time Tᵢ of the previous event. The predefined time Tᵢ is provided by the rule(s) associated with the task and/or work pattern being quantified.

The quantifier tool (507) may identity focused work patterns by determining continuous interactivity for a specified duration of time. A session may be identified as focused if there a sequence of events lasting more than a predetermined time. For example, if the time period from a first event in the session to the last event is longer then a predefined period, T_{f}. The tool aggregates sequences of events into sequences of focused and unfocused sessions based on predetermined time intervals Tᵢ and T_{f}. The time intervals Tᵢ and T_{f} are defined based on the rules associated with the task and/or work pattern being analyzed, therefore, both time intervals may vary. Additional and/or alternative criteria to time may be used to determine if two events should be considered part of the same coding session, for example, file paths may be used to distinguish between specific projects, comments in the code, the code function being worked, and bugs associated with the code.

Once the collected events are aggregated into session, they are used to generate one or more focus metrics (Step 210). A focus metric that may be generated based on the event sessions is a focus index. Research shows that creative work, for example, coding, design, document authoring, and the like, is best done in long, uninterrupted periods of time. To encourage knowledge workers to engage in behavior that allows them long uninterrupted periods of time to focus on their creative work, the quantifier tool (507) may compute a Focus Index based on the following formula:

$$FocusIndex = \frac{{\sum }_{s ∈ All} {T}_{s}}{{\sum }_{s ∈ Focused} {T}_{s} + \vert {T}_{s} : s ∈ Unfocused \vert} ,$$

where Ts is the length of the session s, All is the set of all sessions, Focused is the set of focused sessions, i.e., sessions that are at least T_{f} long), and Unfocused is the set of unfocused sessions (sessions that are less than T_{f} long). The Focus Index expects all sessions to be focused and charges a penalty when a session is instead unfocused. The focus index ranges from 0, no focused sessions, to 1, all work done in long focused time sessions. A value between 0 and 1 represents some focused work mixed with some unfocused work. The focus index may be used to quantify the work pattern at different levels of granularity discussed below in more detail with respect to FIGS. 3A-3C (Step 212).

Another focus metric is an efficiency index. The efficiency index quantifies the efficiency of a work pattern by capturing the cost that comes from context switching between tasks. For simplicity it may be assumed that when a session ends, a context switch has happened. Assuming each session represents the worker's work on a single task, and assuming a context switch overhead of T_{cs}, then an Efficiency Index may be defined as follows:

$$Efficiency Index = \frac{{\sum }_{s ∈ All} {T}_{s}}{{\sum }_{s ∈ All} ( {T}_{s} + {T}_{cs} )}$$

where Tₛ is the length of the session s, and All is the set of all sessions. Minimizing the context switches, for example by increasing focused session lengths, maximizes the Efficiency Index. The efficiency index may be used to quantify the work pattern at different levels of granularity discussed below in more detail with respect to FIGS. 3A-3C.

Another focus metric is a fragmentation index. Fragmentation is the opposite of focus. The quantifier tool (507) may use the focus index to approximate fragmentation. However, sometimes it is important to know not just the percentage of time spent in fragmentation, but also the degree of fragmentation.

Analysis has shown that a shape parameter can be used to approximate the degree of fragmentation. Therefore, the quantifier tool (507) may compute a fragmentation index by fitting task sessions into a Pareto distribution, and computing the shape parameter as:

$$FragIndex = \hat{∝} = \frac{\vert All \vert}{{\sum }_{s ∈ All} ( ln {T}_{s} - ln {T}_{m i n} )} ,$$

where Tₛ is the length of the session s, and Tₘᵢₙ is the length of the shortest session. Assuming that a worker's day is divided in alternating sessions of work and sessions of interruption, a Fragmentation Index may be computed for work sessions, and a Fragmentation Index may be computed for interruption sessions to characterize the degree of fragmentation.

The quantifier tool (507) may also keep track of times when a worker is multi-tasking, that is performing more than one task at a time. Context switching happens when a worker switches from one task to another sequentially. In contrast, multi-tasking occurs with when a worker is focused on multiple tasks at the same time. For example, the quantifier tool (507) may log when and the amount of times that emails are sent during meetings, measured in amount of time or amount of emails processed. The quantifier tool (507) may know that the worker is in a meeting using information such as global positioning or calendar meeting invites. The quantifier tool (507) may also record the duration of time that a worker spends on an email system and emailing during a coding session. Multi-tasking may be identified by correlating task/service specific sessions. For example, if a coding session was logged from 10 am to 11 am and there was also an email session detected from 10:15 am to 10:20 am the overlapping of the two task sessions indicates the work is multi-tasking.

Socializing Score

The quantifier tool (507) may also incorporate social aspects into a work pattern, for example, collaboration between workers may be found to impact various work patterns. Therefore, the quantifier tool (507) may measure the number of people a worker meets per week using information such as calendar events, co-presence in the same location, and interaction on social media. The quantifier tool (507) may use near field communication, global positioning system, or some other location capability in order to determine if people are together. The quantifier tool (507) may additionally look at calendar events and the people who are invited to the same event. This information may be used to calculate a socializing metric. For example, the number of new people met per week and/or the number of people in a social network.

Furthermore, a centrality score in a connected social graph may be computed. Any interaction between a worker and another person may be used to create a social graph for the worker. The social graph may use information from places such as a calendar, email, a code review, social networks, and location awareness. Edge weight of the social graph may be calculated using interactions that the worker. For example, each node in the graph may represent a person/worker and an edge linking nodes A and B means that A and B have interacted with each other via some means. The weight of the edge represents how often they interact. The quantifier tool (507) may use the socializing score and/or other social metric discussed above to generate work pattern rules and/or quantify task/work patterns.

Referring back to FIG. 5, the quantifier tool (507) includes a user interface 509 for providing quantified work pattern feedback to the worker at different levels of granularity. The user interface may include a mobile (301) or desktop (303) application which provides one or more quantified summaries or conclusions based on the calculated focus metrics.

As shown in FIG. 3B, the user interface may provide feedback to workers in multiple ways. For example the user interface (509) may show current and historic focus metrics in time series 305 so workers may visualize their current focus and how they are trending based on their past work patterns. Raw data can also be shown as overlay on top of a calendar, for example, to help workers diagnose productivity issues. FIG. 3D illustrates a calendar overlay. The user interface (509) may also let users set goals and compare their progress relative to these goals (313).

By quantizing work patterns, the quantifier tool (507) may provide worker insights that are not necessarily obvious to the users. For example, the quantifier tool (507) may detect the most productive time of day, day of week, or week of month, using historic focus data (321). The quantifier tool (507) may also detect correlations between events using data mining techniques. For example, the quantifier tool (507) may detect a high correlation between going to bed early and elevated productivity levels the next day.

In addition to providing above noted quantified feedback, the tool may coach or suggest actions designed to increase focus time based on insights and focus metrics it collects. For example, the user interface may suggest scheduling set time periods for checking emails instead of frequently throughout the day, marking blocks of time a busy on your calendar to prevent meeting being scheduled during coding time. FIG. 3C illustrates a coaching feedback.

These insights and recommendations can be delivered in multiple channels. They may be shown in the application at certain times of day, delivered as an email digest, or delivered as notifications in desktop or mobile devices.

The availability of large amounts of event data makes it possible to build quantitative models of work patterns. These quantitative models may be adaptive and continuously update themselves with the latest event data. By applying behavior analytics, the quantifier tool (507) can learn insights and present them to workers to improve productivity.

In general behavior analytics take two forms:

Approach 1: Unsupervised Learning

An embodiment may be able to identify frequently concurrent events or patterns by using data mining techniques such as frequent-item set mining. The learned patterns can be curated and presented to workers.

Clustering may be used to group similar behaviors and identify behavior profiles for different worker categories, for example, engineers, administrators, attorneys, coders and the like. The quantifier tool (507) may be able to provide tailored recommendations based the group profile to which a worker belongs. Highly productive workers may be profiled and their profiles may serve as “role model” profiles to other workers, with the expectation that other workers may emulate the behavior of the role model profiles.

Approach 2: Supervised Learning

Supervised learning requires labeled training data. The training data my correspond to a sequence of activities, for example, coding sessions, captured by the quantifier tool (507) which has been labeled to identify the corresponding focus during the session. The label may, for example, be a number indicating a degree of focus for a certain period of time or a true/false bit. The quantifier tool (507) may survey workers about their productivity at appropriate moments. For example, the surveys may ask workers to rate their perceived productivity and/or focus on a predefined scale. Answers from the workers may serve as labeled training data. In an embodiment, a productivity model may be built based on the behavior data and labeled training data of specific workers. The productivity model may be able to determine when a particular worker is about to enter a period of non-productivity. At that point, the quantifier tool (507) may alert the worker to change behavior to increase productivity.

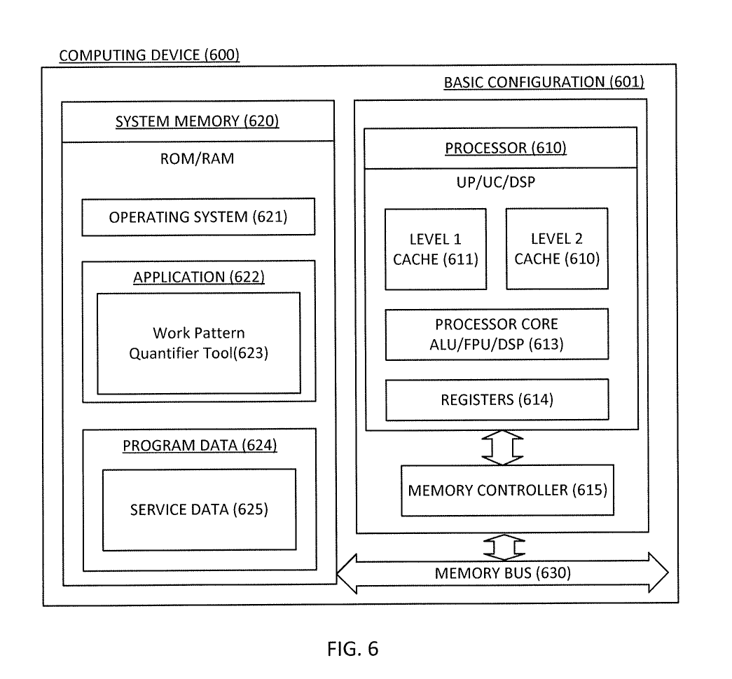

FIG. 6 is a high-level block diagram of a computer (600) that is arranged for automating work pattern quantification and providing worker feedback based on quantified metrics. In a very basic configuration (601), the computing device (600) typically includes one or more processors (610) and system memory (620). A memory bus (630) can be used for communicating between the processor (610) and the system memory (620).

Depending on the desired configuration, the processor (610) can be of any type including but not limited to a microprocessor (μP), a microcontroller (μC), a digital signal processor (DSP), or any combination thereof. The processor (610) can include one more levels of caching, such as a level one cache (611) and a level two cache (612), a processor core (613), and registers (614). The processor core (613) can include an arithmetic logic unit (ALU), a floating point unit (FPU), a digital signal processing core (DSP Core), or any combination thereof. A memory controller (616) can also be used with the processor (610), or in some implementations the memory controller (615) can be an internal part of the processor (610).

Depending on the desired configuration, the system memory (620) can be of any type including but not limited to volatile memory (such as RAM), non-volatile memory (such as ROM, flash memory, etc.) or any combination thereof. System memory (620) typically includes an operating system (621), one or more applications (622), and program data (624). The application (622) may include a work pattern quantifier tool. Program Data (624) includes storing instructions that, when executed by the one or more processing devices, implement a tool for quantifying work patterns (623). In some embodiments, the application (622) can be arranged to operate with program data (624) on an operating system (621).

The computing device (600) can have additional features or functionality, and additional interfaces to facilitate communications between the basic configuration (601) and any required devices and interfaces.

System memory (620) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of the device (600).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), other integrated formats, or as a web service. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., fiber optics cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for automating work pattern quantification and providing worker feedback based on quantified metrics, the method comprising:
identifying a work pattern to be quantified for a user;
determining, using one or more predefined rules associated with the identified work pattern, at least one task associated with the work pattern;
identifying one or more services accessed to perform the at least one task;
collecting events from the one or more determined services, each of the collected events having an associated timestamp;
filtering the collected events to remove events not associated with the at least one task and the user;
aggregating the filtered events into event sessions, wherein an event session is a sequence of events where each subsequent event occurred within a predefined time period Tᵢ of the previous event;
analyzing the event sessions to generate a focus metric associated with the at least one task; and
quantifying the work pattern by providing feedback based on the focus metric.

2. The method of claim 1, wherein analyzing the event sessions includes:
aggregating the event sessions into focused and unfocused sessions; and
generating the focus metric based on the focused and unfocused sessions.

3. The method of claim 2, wherein an event session is a focused session if a time period from the first event in the session to the last event in the session is greater than a predefined time period T_{f}.

4. The method of claim 3, wherein the time periods Tᵢ and T_{f} varying depending on the task associated with the session.

5. The method of claim 3, wherein the focus metric includes a focus index which ranges from 0 to 1, where 0 represents no focused work and 1 represents all work focused.

6. The method of claim 5, wherein the focus index is calculated using the following formula
$$Focus Index = \frac{{\sum }_{s ∈ ALL} {T}_{s}}{{\sum }_{s ∈ Focused} {T}_{s} + \vert {T}_{s} : s ∈ Unfocused \vert} ,$$
where Tₛ is the length of the event session s, ALL is the set of all event sessions, Focused is the set of focused sessions, and Unfocused is the set of unfocused sessions.

7. The method of claim 3, wherein the focus metric includes a fragmentation index calculated using a shape parameter.

8. The method of claim 1, wherein a plurality of tasks are determined to be associated with the work pattern, and analyzing the event sessions to generate a focus metric includes:
identifying event sessions having overlapping time periods as multi-tasking sessions; and
generating the focus metric based on the multi-tasking sessions.

9. The method of claim 1, wherein quantifying the work pattern by providing feedback based on the focus metric includes:
providing a user interface which provides one or more quantified summaries related to the tasks associated with identified work pattern at predetermined levels of granularity.

10. The method of claim 9, wherein the predetermined levels of granularity include one or more of daily, weekly, monthly, quarterly, and yearly.

11. The method of claim 9, wherein the user interface further provides interactive coaching goals.

12. A system for automating work pattern quantification and providing worker feedback based on quantified metrics, the system comprising:
one or more processing devices;
one or more storage devices storing instructions that, when executed by the one or more processing devices, cause the one or more processing devices to
identifying a work pattern to be quantified for a user;
determining, using one or more predefined rules associated with the identified work pattern, at least one task associated with the work pattern;
identifying one or more services accessed to perform the at least one task;
collecting events from the one or more determined services, each of the collected events having an associated timestamp;
filtering the collected events to remove events not associated with the at least one task and the user;
aggregating the filtered events into event sessions, wherein an event session is a sequence of events where each subsequent event occurred within a predefined time period Tᵢ of the previous event;
analyzing the event sessions to generate a focus metric associated with at least one task; and
quantifying the work pattern by providing feedback based on the focus metric.

13. The system of claim 12, wherein analyzing the event sessions further causes the one or more processing devices to
aggregate the sessions into focused and unfocused sessions; and
generate the focus metric based on the focused and unfocused sessions.

14. The system of claim 13, wherein an event session is a focused session if a time period from the first event in the session to the last event in the session is greater than a predefined time period T_{f}.

15. The system of claim 14, wherein the time periods Tᵢ and T_{f} varying depending on the task associated with the session.

16. The system of claim 14, wherein the focus metric includes a focus index which ranges from 0 to 1, where 0 represents no focused work and 1 represents all work focused.

17. The system of claim 16, wherein the focus index is calculated using the following formula
$$Focus Index = \frac{{\sum }_{s ∈ ALL} {T}_{s}}{{\sum }_{s ∈ Focused} {T}_{s} + \vert {T}_{s} : s ∈ Unfocused \vert} ,$$
where Tₛ is the length of the event session s, ALL is the set of all event sessions, Focused is the set of focused sessions, and Unfocused is the set of unfocused sessions.

18. The system of claim 14, wherein the focus metric includes a fragmentation index calculated using a shape parameter.

19. The system of claim 12, wherein a plurality of tasks are determined to be associated with the work pattern, and analyzing the event sessions to generate a focus metric further causes the one or more processing devices to
identify event sessions having overlapping time periods as multi-tasking sessions; and
generating the focus metric based on the multi-tasking sessions.

20. The system of claim 12, wherein quantifying the work pattern by providing feedback based on the focus metric further causes the one or more processing devices to
provide a user interface which provides one or more quantified summaries related to the tasks associated with identified work pattern at predetermined levels of granularity.

21. The system of claim 20, wherein the predetermined levels of granularity include one or more of daily, weekly, monthly, quarterly, and yearly.

22. The system of claim 20, wherein the user interface further provides interactive coaching goals.
